(19) United States
(12) Patent Application Publication
(10) Pub. No.: US 2009/0110149 A1
(43) Pub. Date: Apr. 30, 2009

(54) High Speed X-Ray System

(75) Inventor: Heinz HORBASCHEK, Erlangen (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Siemens Aktiengesellschaft

(21) Appl. No.: 11/926,771

(22) Filed: Oct. 29, 2007

(51) Int. Cl. H05G 1/08; H05G 1/64

(52) U.S. Cl. 378/98.8; 378/98.2

(57) ABSTRACT

A high frame rate X-ray system has an X-ray generator and detector for detecting the X-ray radiation from the X-ray generator, wherein the X-ray generator continuously generates X-rays while X-ray images are captured with a high frame rate by the detector.

### TECHNICAL FIELD

The technical field of the present application relates to a high frame rate x-ray system and to a method for taking X-ray images with a high frame rate. More particularly, the system and method allows a frame rate of over, for example, 1000 frames per second and therefore allows, for example, the capture of movements of subjects.

### BACKGROUND

A typical X-ray apparatus for producing images of subjects being substantially motionless includes an X-ray generating unit and an X-ray detecting unit. In the X-ray apparatus, the X-ray detecting unit generally includes an X-ray film or an I.I. (X-ray image intensifier) as a detector. As an X-ray film conventional cinema film may be used. A subject, e.g. a patient or an animal, is placed between the X-ray generating unit and the X-ray detecting unit. According to an X-ray imaging method, X-rays pulsed from the X-ray generating unit are exposed to the subject. The X-rays are pulsed because this results in no blurring of an image taken. X-ray projection data obtained from X-rays passed through the subject is converted into an optical image. The optical image may be captured by a TV camera and the captured image is converted into electric signals. The resultant signals may be displayed on a monitor.

In a system using a TV camera the X-ray radiation is in synchronism with the TV scan timing and images are read out with 60 frames per second. The imaging method realizes real-time imaging which is impossible by an imaging method using a film. In other words, the conventional pulsed X-ray systems using a TV system do not allow a higher frame rate than 60 frames per second. Conventional pulsed X-ray systems using a film do not allow a higher frame rate than around 150 frames per second because of the mechanical and technical limitations involved in moving the film.

In recent years, attention has been given to image systems having more than one image system. Such an image system may be a biplane type X-ray apparatus having two imaging systems and a relative angle defined by the crossing angle between the imaging central axes (each axis formed between the center of an X-ray generating unit and the center of the corresponding X-ray detecting unit) of the two imaging systems is set based on palmic information obtained from a subject.

In view of the prior art discussed above, there is a need to provide a system and method allowing for a much higher frame rate of the images than the conventional prior art. This would allow X-ray images to be taken from a moving subject. Such images would need to have a satisfying time resolution. For example, such images need to be free of blur. To achieve an acceptable image the frame rate would need to be much higher than the present 60 or 150 frames per second.

A further problem underlying the use of X-ray in the first place is how to study the skeletal movements of animals. Such studies could lead to observations that could be applied in science, such as mechanical engineering.

Additionally, it is desirable to avoid the cumbersome arrangements connected with pulsed X-ray radiation.

### SUMMARY

In one embodiment, a high frame rate X-ray system may comprise X-ray generating means and detecting means for detecting the X-ray radiation from the X-ray generating means, wherein the X-ray generating means continuously generates X-rays while X-ray images are captured with a high frame rate by the detecting means. According to further embodiments, the X-ray generating means may comprise one or more X-ray tubes and the detecting means comprises one or more corresponding cameras. For shortening the exposure time, one or more cameras may comprise a shutter function. In a further embodiment, the X-ray generating means may comprise one or more X-ray tubes and the detecting means comprises one or more corresponding CCD cameras. According to further embodiments, the detecting means may comprise one or more cameras and the system further comprises one or more corresponding live cameras, wherein all cameras are synchronized, whereby the X-ray images have corresponding live images. In further embodiments, the system may be a monoplane or a biplane X-ray system. According to further embodiments the frame rate is 250, 500, 1000, 1500, 2000, 2500 or 3000 frames per second.

In one embodiment a method for taking X-ray images with a high frame rate, may comprise the steps of radiating X-rays continuously while X-ray images are captured and capturing X-ray images with a high frame rate by detecting means. According to further embodiments, the frame rate is 250, 500, 1000, 1500, 2000, 2500 or 3000 frames per second. In a further embodiment, the X-ray images are captured by a camera, preferably a CCD camera. In a further embodiment, the exposure time of a camera for capturing the X-ray images is shortened by using a shutter function of the camera.

In one embodiment, a high frame rate X-ray system may comprise a plurality of X-ray tubes and an X-ray detector for detecting the X-ray radiation from the X-ray tubes, wherein the X-ray tubes continuously generates X-rays while X-ray images are captured by the detector with a frame rate higher than 250 frames per second. In a further embodiment, the detector is a camera with a shutter for shortening the exposure time. Preferably, the detector is a CCD camera. In further embodiments, the frame rate is 250, 500, 1000, 1500, 2000, 2500 or 3000 frames per second. In a further embodiment, the system is a biplane X-ray system.

In one embodiment, a method for taking X-ray images with a high frame rate may comprise the steps of radiating X-rays continuously while X-ray images are captured, capturing X-ray images with a high frame rate higher than 250 by one or more cameras, capturing live images with one or more live cameras, and synchronizing the X-ray images and the live images, whereby the X-ray images have corresponding live images. In a further embodiment, the X-ray images are captured by a CCD camera.

Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any preceding claimed embodiment(s).

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain, by way of example, the principles of the invention.

FIG. 1 is a block diagram of an X-ray system.

FIG. 2 is a timing chart for continuous X-ray radiation according to a first embodiment.

FIG. 3 is a timing chart for continuous X-ray radiation with the exposure time reduced by the use of a shutter according to a second embodiment.

### DETAILED DESCRIPTION

In the following, the expression “radiating X-rays continuously” means that X-rays are generated continuously for at least the time the X-ray images are taken. Furthermore, the expression “high frame rate” means a considerably higher frame rate than the standard 60 to 150 frames per second taken with conventional pulsed X-ray systems. The high frame rate allows moving subjects to be captured with satisfying time resolution, which results, for example, in images without blur. In fact, the various embodiments described work, for example, with a high frame rate of 500 frames per second or more.

The hereinafter described system and method may be used for capturing images from any kind of subjects. However, the described system and method is particularly suitable for capturing movements of animals or any other kind of living organism.

In one embodiment, a high frame rate X-ray system may comprise X-ray generating means and detecting means for detecting the X-ray radiation from the X-ray generating means, wherein the X-ray generating means continuously generates X-rays while X-ray images are captured with a high frame rate by the detecting means.

In one embodiment, a method for taking X-ray images with a high frame rate may comprise the steps of radiating X-rays continuously while X-ray images are captured, and capturing X-ray images with a high frame rate by detecting means.

The herein described embodiments allow a plurality of images to capture the complete desired movement of a subject. By continuously radiating X-rays for the complete time images are taken from the subject, the scanning time of the detecting means becomes the exposure time. The system and method may further comprise one or more X-ray tubes and one or more corresponding cameras. The exposure time of the camera(s) may be shortened by using a shutter function of each camera.

In another embodiment, the system and method may comprise one or more X-ray tubes and one or more corresponding CCD cameras (CCD detector). A CCD detector converts the X-ray radiation into digital images. Such images may comprise a matrix of pixels with each pixel coded digitally. The detector may be of flat-panel design, such as a single piece flat-panel using, for example, Cesium Iodide scintillator technology. Other methods to detect X-ray radiation may be used, for example, such as slot scan, tiled CCD arrays (employing multiple CDDs coupled to a scintillator plate via fiber optics), direct conversion (using flat-panel Selenium detectors), or computer radiography (using photo stimulated plates).

Embodiments of the system and method may further comprise a monoplane or biplane X-ray system. Furthermore, embodiments of the system and method may comprise a signal processing unit.

The frame rate of the system, and achieved by the method, may be a frame rate of 250, 250, 500, 1000, 1500, 2000, 2500 or 3000 frames per second. The frame rate is not limited to these examples and may be any rate up to several thousands. The inertia of the detector normally sets the upper limit of the frame rate to something in the region of 3000 frames per second.

In another embodiment, the system and method may comprise live cameras taking live images in addition to the cameras for the X-ray radiation. The images from the live cameras and the X-ray may be synchronized, allowing a live image from the subject to have a corresponding X-ray image of the subject. By having the two types of images, the movements of the subject may be studied by using the X-ray images and the corresponding live images.

To achieve a very high frame rate for X-ray images when using X-ray image intensifiers (I.I.) in combination with TV cameras something else than the present technology, such as detectors running with a maximum of 60 frames per second, needs to be used. TV cameras with a good resolution in combination with very high light sensitiveness are preferred for the 1.1's. Very high light sensitiveness makes a low dose mode possible, which allows a subject to be X-rayed by a very low radiation dose. Any number of cameras from, e.g. 1 to 10 may be used. The control of the cameras may be done by a high performance PC, which also provides fast image processing.

With a pulsed X-ray it is not possible to achieve X-ray images with a high frame rate. Embodiments of the present invention overcome this technical limitation achieve a high frame rate by using continuous X-ray radiation. X-ray generating means may generate X-rays continuously for the time the X-ray images are taken so that a complete movement of the subject can be recorded.

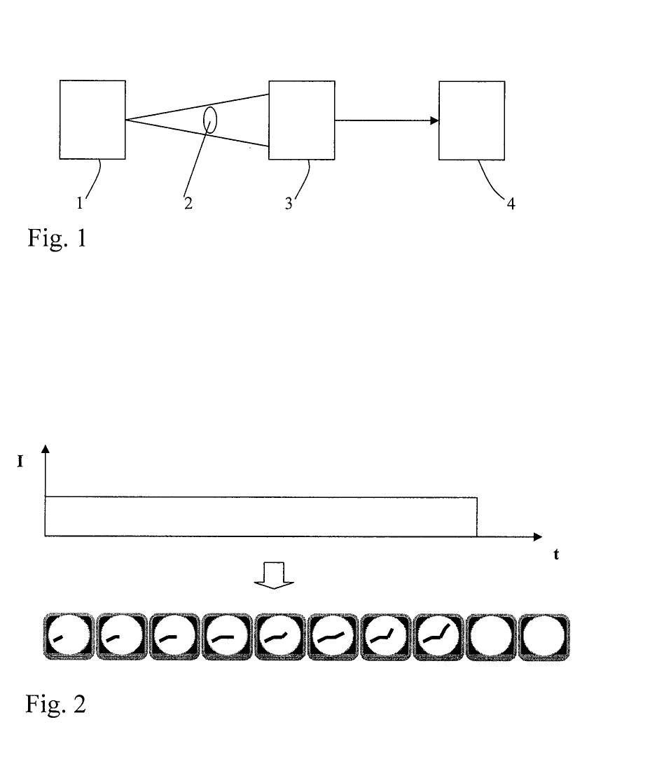

In FIG. 1, an X-ray system according to an embodiment is shown. Such an X-ray generating means (1) may comprise an X-ray tube, which generates an X-ray beam. X-rays radiated by the X-ray tube pass through a subject (2) and enter a detecting means (3). The X-ray beam is incident to the detecting means (3). The output of the detecting means (3) may be coupled to a signal processing unit (4) for converting the X-ray radiation into an electrical signal sequence and to process such a signal.

The detecting means (3) may comprise a camera according to an embodiment, such as a TV camera or a CCD camera for detecting the X-rays. There are several types of individual detector elements which can be used. A preferred way of converting the X-ray energy to an electrical signal may be by means of a photomultiplier, photo diode, CCD, flat-panel or similar device. The detecting means (3) may comprise an I.I. for converting the X-rays to an optical image. The optical image may then be picked up by the camera. The camera may be, for example, a video camera, a CCD converter, flat-panel, or an I.I. having an integrated semiconductor transducer. Preferably such a camera may be a CCD camera. Alternatively, scintillators could be placed in direct or close contact with an array of photo diodes, photo transistors or charge coupled devices (CCDs) to achieve a rugged and compact detector. Where solid state devices, particularly CCDs, are used, cooling, such as with a Peltier-type cooler, or the like, may be employed to increase the signal-to-noise ratio of the device. Alternatively, the scintillator array could be placed in direct or close contact with one or more position sensitive photomultiplier tubes which provide an output signal which identifies the position coordinates of the light sources as well as its amplitude.

The use of a high speed camera to capture the continuous X-radiation passing through the subject would allow for frame rates, for example, in the size of 250, 500, 1000, 1500, 2000, 2500 or 3000 frames per second, or even higher. Such frame rates would allow images to be taken from moving subjects with a high time resolution, resulting, for example in images without blur.

According to an embodiment, the signal processing unit (4) may be part of a video chain which includes and image memory and display monitor. The camera outputs a video signal, which in turn is converted to a digital signal by the signal processing unit (4), for example by a A/D converter. The digital signal may subsequently be stored in a memory. The images may be viewed as a film instantly or stored in a memory for later viewing and/or editing.

FIG. 2 shows a curve of signal arising during operation of the installation shown in the embodiment of FIG. 1 and a resulting row of images. In FIG. 2 the intensity (I) of the X-radiation is entered over time (t). The curve represents a continuous X-radiation. During this continuous X-radiation the X-ray projection data obtained from X-rays passed through the subject is converted into an optical image. The optical image may be captured by a TV camera and the captured image is converted into electric signals. The images are schematically shown over time below the curve in FIG. 2. The progress of a moving subject has been schematically drawn in the individual images of the frames. The exposure time is given by the scan timing of the camera. For example, with cameras run at 1000 frames per second the exposure time is one ms, and at 500 frames per second the exposure time is two ms.

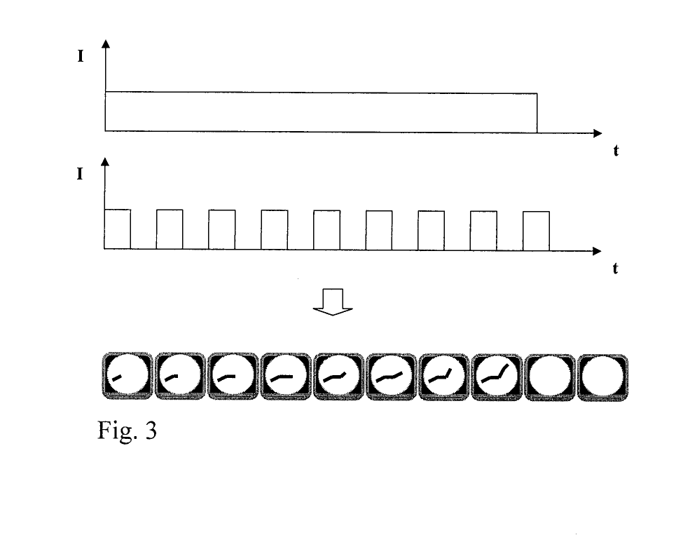

FIG. 3 shows two curves and a row of images. The upper curve is the same curve as shown in FIG. 2, with the intensity (I) of the X-radiation entered over time (t). The lower curve shows how the continuous X-radiation is affected by a shutter. In some situations it might be desirable to have an even shorter exposure time to avoid, for example, images with blur and similar motion artifacts arising out of a moving subject. To achieve this, according to an embodiment, a shutter can be used. The shutter can be an electrical or mechanical shutter. A modern focal plane shutter can achieve exposure times as short as 1/8000 second. By using, for example, the internal shutter function of each camera, the exposure time can be reduced to a very short period, for example down to 0.2 ms. This would allow for high frame rates, for example, 250, 500, 1000, 1500, 2000, 2500 or 3000 frames per second, or even higher. Additionally, for very small animals the overall dose charge is very low, so the skipped part of the dose caused by the shutter can be accepted easily.

In addition, according to an embodiment, scene cameras may be used. These cameras could be light sensitive to avoid too bright additional illumination of the subject. With respect to the signal processing unit, according to an embodiment, comprehensive image processing algorithms can be used, for example, for contrast and sharpness enhancement or data compression.

The maximum duration of the X-ray radiation preferably exceeds the scene time of the camera to be recorded, allowing the subject to be watched through X-ray images. When the subject is, for example, a small animal the overall dose charge is basically very low. This shall not exclude human beings, for which the system and method may be applicable.

More specifically, the method for taking X-ray images with a high frame rate may comprise the steps of radiating X-rays continuously while X-ray images are captured and capturing X-ray images with a high frame rate by detecting means. The frame rate may be 250, 500, 1000, 1500, 2000, 2500 or 3000 frames per second. Preferably, according to an embodiment, the X-ray images are captured by a camera. The exposure time of the camera may be further shortened by using a shutter function, for example, of each camera. According to one embodiment, the X-ray images are captured by a CCD camera.

The system can be used by positioning a subject (2) to be X-rayed between the X-ray generating means (1) and the X-ray detecting means (3). The X-ray parameters are selected depending on the desired frame rate. A desired shutter time may be set and a desired X-ray dose may be set. Next all cameras are switched to the recording mode, allowing for the X-ray to be started. After capturing a desired row of images the X-ray is stopped. The scenes are immediately present after the run for viewing or for storing. Thus, it can easily be checked whether the desired motion of the subject was captured. The display frame rate can be selected in a wide range and comprehensive image processing algorithms can be used, for example, for contrast and sharpness enhancement or data compression.

Additionally, according to an embodiment, one or more live cameras (scene cameras) can be used in combination with the X-ray system, to take images showing the subject moving. Naturally, these images are not X-ray images.

In one embodiment of the method, the exposure time is 1 ms at a frame rate of 1000 frames per second. Correspondingly, the exposure time would be 2 ms at a frame rate of 500 frames per second. For subjects moving very fast, this could be a too long exposure time, resulting in no satisfying time resolution, for example blurred images. However, with the shutter function of each camera, the exposure time can be reduced to very low values at every selected frame rate. For example, the effective exposure time can be shortened to a very short time, for example 0.2 ms, to achieve a satisfying time resolution.

According to a further embodiment, the system and method may make use of a high end X-ray system called Neurostar from Siemens. Contrary to the standard configuration of the Neurostar with a 16 inch (40.6 cm) and a 12 inch (30.5 cm) I.I., two 16 inch (40.6 cm) types may be used. To achieve a high frame rate the full power of, for example, the three foci of the X-ray tube may be used.

According to a further embodiment, as a camera a first class high speed camera SPEEDCAM visario g2 from Weinberger-Vision Company in Erlangen in Germany may be selected. They provide high light sensitiveness together with excellent resolution and run with 1000 frames per second at a matrix of 1536 by 1024, with some overframing even 2000 frames per second at 1024 by 768 pixels. The Nikon Nikkor Optics with a focal distance of 50 mm and a maximum aperture of 1:1.2 provides good sharpness and high light transmission. This results in a system running in a very low dose mode with a minimum on x-ray radiation.

The system and method discussed above captures X-ray images with a high frame rate. The invention, therefore, is well adapted to carry out the objects and attain the ends and advantages mentioned, as well as others inherent therein. While the invention has been described and is defined by reference to particular preferred embodiments of the invention, such references do not imply a limitation on the invention, and no such limitation is to be inferred. The invention is capable of considerable modification, alteration, and equivalents in form and function, as will occur to those ordinarily skilled in the pertinent arts. The described preferred embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. A high frame rate X-ray system, comprising:
X-ray generating means and detecting means for detecting the X-ray radiation from the X-ray generating means,
wherein the X-ray generating means continuously generates X-rays while X-ray images are captured with a high frame rate by the detecting means.

2. The high frame rate X-ray system according to claim 1, wherein the X-ray generating means comprises one or more X-ray tubes and the detecting means comprises one or more corresponding cameras.

3. The high frame rate X-ray system according to claim 2, wherein the one or more cameras comprises a shutter function for shortening the exposure time.

4. The high frame rate X-ray system according to claim 1, wherein the X-ray generating means comprises one or more X-ray tubes and the detecting means comprises one or more corresponding CCD cameras.

5. The high frame rate X-ray system according to claim 1, wherein the detecting means comprises one or more cameras and the system further comprises one or more corresponding live cameras, wherein all cameras are synchronized, whereby the X-ray images have corresponding live images.

6. The high frame rate X-ray system according to claim 1, wherein the system is a monoplane X-ray system.

7. The high frame rate X-ray system according to claim 1, wherein the system is a biplane X-ray system.

8. The high frame rate X-ray system according to claim 1, wherein the frame rate is 250, 500, 1000, 1500, 2000, 2500 or 3000 frames per second.

9. A method for taking X-ray images with a high frame rate, comprising the steps of:
radiating X-rays continuously while X-ray images are captured; and
capturing X-ray images with a high frame rate by detecting means.

10. The method according to claim 9, wherein the frame rate is 250, 500, 1000, 1500, 2000, 2500 or 3000 frames per second.

11. The method according to claim 9, wherein the X-ray images are captured by a camera.

12. The method according to claim 9, wherein the X-ray images are captured by a CCD camera.

13. The method according to claim 9, wherein the exposure time of a camera for capturing the X-ray images is shortened by using a shutter function of the camera.

14. A high frame rate X-ray system, comprising:
a plurality of X-ray tubes;
an X-ray detector for detecting the X-ray radiation from the X-ray tubes,
wherein the X-ray tubes continuously generates X-rays while X-ray images are captured by the detector with a frame rate higher than 250 frames per second.

15. The high frame rate X-ray system according to claim 14, wherein the detector is a camera with a shutter for shortening the exposure time.

16. The high frame rate X-ray system according to claim 14, wherein the detector is a CCD camera.

17. The high frame rate X-ray system according to claim 14, wherein the frame rate is 250, 500, 1000, 1500, 2000, 2500 or 3000 frames per second.

18. The high frame rate X-ray system according to claim 14, wherein the system is a biplane X-ray system.

19. A method for taking X-ray images with a high frame rate, comprising the steps of:
radiating X-rays continuously while X-ray images are captured;
capturing X-ray images with a high frame rate higher than 250 by one or more cameras;
capturing live images with one or more live cameras; and
synchronizing the X-ray images and the live images, whereby the X-ray images have corresponding live images.

20. The method according to claim 19, wherein the X-ray images are captured by a CCD camera.
